(19) United States
(12) Patent Application Publication
(10) Pub. No.: US 2009/0022767 A1
(43) Pub. Date: Jan. 22, 2009

(54) COMPOSITION, DEVICE AND METHOD FOR TRANSDERMAL DELIVERY OF INSECT REPELLENT

(75) Inventors: Chari Fisher Kauffman, Pearland, TX (US); Patricia Z. Tompkins, Hempstead, TX (US); William Garrett Kauffman, Pearland, TX (US)

Correspondence Address: DUANE MORRIS LLP - Chicago;IP DEPARTMENT, 190 South LaSalle Street, Suite 3700, CHICAGO, IL, 60603-3433, US

(73) Assignee: Diva Marketing Group, LLC, Hempstead, TX (US)

(21) Appl. No.: 12/175,084

(22) Filed: Jul. 17, 2008

Related U.S. Application Data
(60) Provisional application No. 60/961,010, filed on Jul. 18, 2007.

(51) Int. Cl. A01N 25/34; A01P 17/00

(52) U.S. Cl. 424/405

(57) ABSTRACT

A composition, device and method for the transdermal delivery of effective amounts of insect repellent provide a transdermal patch having a backing layer formed of a breathable, skin-like material such as urethane, a removable liner layer and a drug formulation and adhesive disposed between the backing layer and the liner layer. The drug formulation includes Vitamin B1 which is a thermally diffusible insect repellant, and aloe vera which accelerates the diffusion of the Vitamin B1 into a wearer's skin and bloodstream. The liner layer is removed and the patch affixed to a wearer's skin by means of the adhesive, and repels insect bites for 36 hours or more.

### RELATED APPLICATION

This application is related to, and claims priority from U.S. Provisional Patent Application No. 60/961,010, entitled Composition and Method for Transdermal Delivery of Insect Repellant, filed Jul. 18, 2007, the contents of which are herein incorporated by reference as if set forth in their entirety.

### FIELD OF THE INVENTION

The present invention relates to a composition, device and method for the transdermal delivery of a composition in effective amounts to repel insects. More particularly, the present invention relates to the transdermal delivery of an insect repellent agent to a wearer over an effective time period by providing a transdermal patch and affixing the same to the skin of the wearer.

### BACKGROUND

Controlling the spread of deadly diseases by insects such as mosquitoes and biting flies has become a priority throughout the world. Disease organisms transmitted by mosquitoes include West Nile virus, Saint Louis encephalitis virus, Eastern equine encephalomyelitis virus, Everglades virus, Highlands J virus, La Crosse Encephalitis virus in the United States; dengue fever, yellow fever, Ilheus virus, and malaria in the American tropics; Rift Valley fever, Wuchereria bancrofti, Japanese Encephalitis, dengue fever, yellow fever, chikungunya and malaria in Africa and Asia; and Murray Valley encephalitis in Australia.

World organizations and national governments are faced with the daily challenge of protecting the general populations from these devastating diseases and balancing economic pressures. Unfortunately, preventive medicine usually becomes a low priority.

Additionally, traditional vaccines such as may be used to deliver a dose of insect repellant, are expensive and in some applications, dangerous; further, they do not always reach those who most need them due to cultural issues or geographic challenges. Medical personnel needed to administer these medicines are scarce and at a premium in third world countries and in those countries that are engaged in constant military conflict.

Industrial countries are likewise challenged. In the United States, states with sizeable mosquito-control programs include California, Florida, New Jersey, Louisiana, Minnesota, Michigan, North Dakota, and Texas, among others. West Nile has recently made its appearance, killing many in its wake. With the United States military in active combat zones under less than desirable conditions such as swamps and deserts, protection from insects and the diseases they spread is of paramount importance.

Long-range, intelligent, ecologically valid, and environmentally sound pest control may be approached using various available control methods collectively known as integrated pest management (IPM). Typical mosquito-control programs using IPM first conduct larval and adult surveys in order to determine the species' composition, relative abundance, and seasonal distribution of adult and larval mosquitoes, and only then are the best and most effective control methods utilized. However, some of the IPM's have used undesirable pesticides such as DDT, which although effective against disease ridden insects, can prove fatal to humans and cause birth defects.

Confronted with these challenges, the medical community has reached out and examined ways to deliver the needed protections against insect-borne diseases in an inexpensive and effective manner. The medium of delivery of these drugs has always been an obstacle.

Over the past decade or so, the transdermal delivery of drugs has gained favor as an alternative to traditional “shot in the arm” treatments and transdermal patches for the delivery of agents and drugs have become even more ubiquitous in recent years. The pharmaceutical industry appears to favor the utilization of transdermal patches for delivering and facilitating drug delivery without the use of a needle. The benefits are safe and effective delivery of drugs to persons who have a fear of needles in addition to the convenience of using a simple contained patch instead of a delicate syringe, which requires a prerequisite skill for proper injection. Moreover, repeated injections can cause long-term problems for a patient and can be life threatening.

Wick et al., U.S. Pat. No. 6,010,715 discloses a transdermal patch for controlled release of an active agent (e.g., nicotine) wherein the active agent is dissolved or suspended into a monolithic polymer film without the use of solvents. The device is a laminate comprising the monolithic carrier layer, a backing layer that is impermeable to the active ingredient, and a pressure-sensitive, active-ingredient permeable, adhesive layer.

Ueda et al., U.S. Pat. No. 4,889,721, discloses a transdermal system that includes at least two adhesive layers in which one of the layers other than the one furthest from the skin contains a solid powder which can include, inter alia, zinc oxide. The rate of drug release is thus said to be variable based upon the quantity and type of solid powder used. Clonidine is among the large number of drugs recited in this document and is mentioned as being potentially incorporated in a layer with the solid powder.

Gale et al., U.S. Pat. No. 5,840,327 discloses a transdermal drug delivery device designed specifically for enhanced adhesion to sensitive skin areas and directed to the administration of testosterone, estradiol, or progesterone. The device includes a non-aqueous, polymeric reservoir having the active agent and (optionally) skin permeation enhancers dissolved therein. The reservoir is somewhat tacky to facilitate adhesion to the delivery site. The device also includes a non-continuous, patterned (e.g., parallel lines) adhesive layer disposed on the skin-facing side of the reservoir. This is intended to facilitate better adhesion to sensitive areas.

Gale et al., U.S. Pat. No. 5,635,203 discloses transdermal drug delivery devices having at least a drug/permeation reservoir bound to a “tie layer,” which is, in turn, bound to the upper side of an adhesive layer. The tie layer is intended to prevent blooming or de-lamination between the adhesive layer and the reservoir where the reservoir contains a non-ionic surfactant. As disclosed, the reservoir is a matrix having the drug and skin permeation mixture dissolved therein. As claimed, the invention is required to include a skin permeation mixture, e.g., non-ionic surfactant.

Burton, et al., U.S. Pat. No. 5,948,433 discloses a transdermal patch comprising a backing layer, a liner layer, and a drug-containing adhesive layer located between the backing and liner layers. The drug-containing adhesive layer contains polyisobutylene, plasticizer, and filler in preferred ratios and the drug is moderately soluble in the plasticizer.

Wang et al., European Patent No. 525,105, discloses polyisobutylene adhesive compositions in transdermal drug delivery devices which include an oily, non-polar liquid active agent dissolved in a mixture of high molecular weight polyisobutylene and low molecular weight polyisobutylene, and in which the composition is substantially free of plasticizers and tackifiers.

In addition, Black “Transdermal Drug Delivery Systems”, U.S. Pharmacist, November 1982, pp 49-78, provides additional background information regarding commercially available transdermal drug delivery systems. A reasonably complete summary of the factors involved in percutaneous absorption of drugs may be found in Arita, et al, “Studies on Percutaneous Absorption of Drugs”, Chem. Phar. Bull., Vol. 18, 1970, pp 1045-1049; Idson, “Percutaneous Absorption”, J. Phar. Sci., Vol. 64, No. 6, pp 910-922; and Clooney, Advances in Biomedical Engineering, Part I, Chapter 6, “Drug Permeation Through Skin: Controlled Delivery For Topical or Systemic Therapy”, Marcel Dekker, Inc., New York and Basel, 1980, pp 305-318.

The contents of each of the aforementioned references are hereby incorporated by reference, as if set forth in their entireties.

One known insect repellent transdermal patch has failed to provide the proper dosage for effectively repelling biting insects. In particular, the known patch inefficiently provides an excessive amount of insect repellant without providing a mechanism for the efficient transdermal diffusion of the insect repellant in a controlled manner or in a therapeutically useful amount. Another problem in the art is use of polypropylene as a backing layer. Polypropylene is not breathable, causes skin irritations, and leaves a sticky residue when the patch is removed from the skin.

The oral delivery of an insect repellant such as Vitamin B1 includes noted shortcomings. The vitamin may undergo pre-systemic metabolism within the GI tract and liver which results in poor bio-availability; a higher dosage and longer time period are required for the insect repellent to become effective; and, this dosage method is inconsistent because of the reliance upon the digestive tract.

It would therefore be desirable to provide a composition, device and method for administering a therapeutically useful amount of an insect repellant in an efficient and controlled manner.

### SUMMARY OF THE INVENTION

To overcome and solve the shortcomings and limitations of the prior art, the present invention provides a transdermal patch with an effective natural insect repellent formulation.

According to one aspect, provided is a transdermally diffusible insect repellant formed on a transdermal patch and comprising a drug formulation including at least Vitamin B1 and aloe vera.

According to another aspect, provided is a device for transdermally administering a therapeutically useful dose of insect repellant. The device comprises a backing layer comprised of a breathable material and an adhesive and drug formulation affixed to the backing layer. The drug formulation comprises a transdermally diffusible insect repellant and aloe vera. The transdermally diffusible insect repellant comprises at least Vitamin B1. The device may optionally include a layer of further insect repellant on a surface of the backing layer opposite the adhesive and drug formulation.

According to another aspect, provided is a method for transdermally administering a therapeutically useful dose of insect repellant. The method comprises providing a patch having a backing layer formed of a breathable material and having an outer surface. The patch further comprises a drug formulation and adhesive affixed to an opposed inner surface of the backing layer, the drug formulation comprising a transdermally diffusible insect repellant and aloe vera, the transdermally diffusible insect repellant comprising at least Vitamin B1. The method further provides for removably affixing the patch to a wearer's skin by means of an adhesive thereby causing at least the transdermally diffusible insect repellant to diffuse through the wearer's skin.

### BRIEF DESCRIPTION OF THE DRAWING

The present invention is best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Like numerals denote like features throughout the specification and drawing. Included in the drawing are the following figures:

FIG. 1 is a perspective view of one exemplary embodiment of a transdermal patch according to the invention;

FIG. 2 is a perspective view of another exemplary embodiment of a transdermal patch according to the invention;

FIG. 3 is a perspective view, in partial cross-section, of another exemplary embodiment of the transdermal patch according to the invention;

FIG. 4 is a perspective view, in partial cross-section, of yet another exemplary embodiment of a transdermal patch according to the invention;

FIG. 5 is a cross-sectional view showing an exemplary transdermal patch affixed to a wearer's skin after the liner layer has been removed; and

FIG. 6 is a perspective view of yet another exemplary embodiment of a transdermal patch according to the invention.

### DETAILED DESCRIPTION

The present invention provides an insect repellant composition and a device and method for the safe transdermal delivery of a therapeutically useful dose of an inventive insect repellent composition. In accordance with one embodiment of the present invention, a transdermal patch delivers insect repellent in a controlled manner and over an effective period of time to prevent bites from mosquitoes, flies, and other biting insects. The therapeutically useful dose may be a dose that is effective in repelling insects for up to 36 hours or more.

An inventive transdermal patch advantageously administers a drug to a human wearer although the transdermal patch may be used by other animals as well. The transdermal patch includes a removable liner layer and a backing layer opposed the liner layer. A drug formulation including a transdermally diffusible insect repellant such as Vitamin B1, and aloe vera, is interposed along with an adhesive between the liner layer and the backing layer. The drug formulation may be intermixed with the adhesive or in a separate layer or layers. The removable liner layer is a protective layer that is removed prior to the patch being worn by the wearer.

The drug formulation includes Vitamin B1 and aloe vera. Aloe vera increases the absorption rate and also prevents or minimizes skin irritations. The aloe vera includes anti-inflammatory properties which help reduce any swelling or allergic reactions otherwise caused by insect bites. By accelerating the absorption rate of Vitamin B1 into the wearer's skin and bloodstream, the aloe vera provides for an increased efficiency of controlled drug delivery. The transdermally delivered Vitamin B1 is absorbed into the wearer's bloodstream and distributed throughout the wearer's entire body. The transdermal patch and method effectively repel biting insects because a body's natural response when given excess Vitamin B1 such as delivered via diffusion using the inventive transdermal patch and drug formulation, is to excrete the excess Vitamin B1 through its pores. The excretion of Vitamin B1 then camouflages the naturally emitted carbon dioxide which is that which attracts mosquitoes and other biting insects.

Vitamin B1 is also known as thiamin (also spelled “thiamine”) and is a water soluble B-complex vitamin previously known as aneurine. Vitamin B1 was first isolated and characterized in the 1920s, and thus was one of the first organic compounds to be recognized as a vitamin. Synonyms of Vitamin B1 include aneurine HCL, aneurine mononitrate, antiberiberi factor, antiberiberi vitamin, antineuritic factor, antineuritic vitamin, anurine, B complex vitamin, beta-hydroxy-ethylthiazolium chloride, thiamin chloride, thiamin diphosphate, thiamin HCL, thiamin hydrochloride, thiamin monophosphate (TMP), thiamin nitrate, thiamin pyrophosphate (TPP), thiamin triphosphate (TTP), thiamine chloride, thiaminium chloride HCL, and thiaminium chloride hydrochloride.

The effectiveness of the inventive transdermal patch is due to the formulation of components and the transdermal patch delivery system. Vitamin B1 is the active ingredient in the patch and is a transdermally diffusible insect repellent that is diffusible through a human's skin. Vitamin B1 also is an anti-inflammatory agent that greatly inhibits allergic reactions to insect bites. When the aloe vera is mixed with the Vitamin B1, the aloe vera increases the absorption of the ingredients and accelerates diffusion through the skin and to the bloodstream even for people with dry skin. Both the aloe vera and Vitamin B1 ingredients in the inventive transdermal patch are water soluble. Transdermal delivery allows for even and controlled distribution of the Vitamin B1 into the bloodstream. A long lasting insect repellent is provided by the transdermal patch delivery system which allows for the timed release of Vitamin B1 into the bloodstream.

The inventive transdermal patch, according to the embodiment in which a Vitamin B1 and aloe vera drug formulation is used, is effective to repel biting insects such as mosquitoes, ticks, chiggers, gnats, sand fleas and midges, alternatively referred to as no-see-ums. The transdermal patch, as will be seen in the figures, is worn for a therapeutically useful time period chosen in conjunction with the amount of drug formulation provided.

According to yet a further aspect of the invention, the patch may be additionally or alternatively infused with further ingredients such as a nutritional supplement selected to increase energy. According to another aspect of the invention, the patch may be additionally or alternatively infused with a nutritional supplement blend selected to increase energy, and containing antioxidants. According to yet a further aspect of the invention, the patch may be additionally or alternatively infused with ingredients that aid in digestion. According to still another aspect of the invention, the patch may be additionally or alternatively infused with an active ingredient that produces metabolic activities that primarily affect the nerves and/or which primarily affect the muscles. According to still another aspect of the invention, the patch may be additionally or alternatively infused with an active ingredient that that produces metabolic activities that primarily affect cardiovascular system.

In one exemplary embodiment, the drug formulation may include about 5 mg (milligrams) of Vitamin B1 and about 0.5 mg of aloe vera disposed on a transdermal patch. In other exemplary embodiments, the amount of Vitamin B1 may range from about 1 to 10 mg and the amount of aloe vera may range from about 0.1 to 2.0 mg but other absolute and relative amounts of these components may be used in other exemplary embodiments.

The inventive transdermal patch is advantageously applied to clean, dry and hair-free skin for best effectiveness but can be worn at other locations. According to one exemplary embodiment, the transdermal patch can be worn for two hours and should be applied to the wearer's skin two hours prior to being exposed to biting insects. According to other exemplary embodiments, various suitable time periods ranging from thirty minutes to thirty six hours may be used for effectively delivering the therapeutically useful amount of Vitamin B1 transdermally to the wearer. The appropriate time periods may vary based on the total and relative amounts of the ingredients and optional additives in the drug formulations.

According to one exemplary embodiment, the inventive transdermal patch is effective in repelling insect bites for up to 36 hours or more when worn for a time period sufficient to transdermally deliver the dosage to the user.

Because of the aloe vera's qualities of accelerating absorption of Vitamin B1 into the wearer's skin and bloodstream and assisting in preventing any skin irritations from the patch remaining on the wearer's skin for an extended time period, the inventive transdermal patch may be worn for long time periods if desired, without adverse effect.

Transdermal medical delivery and release systems have become the favored method of drug delivery and major pharmaceutical companies now market transdermal patches for dispensing a great variety of pharmaceutical agents. The technology has evolved into a flexible system of single or multi-layered polymeric laminates and reservoir system technology which stores and releases active ingredients under strict rate control. The transdermal delivery and release system provides a highly efficient, safe and easy to use method for delivering active ingredients and other compounds to the body through intact skin, thereby offering many advantages over traditional dosage forms. The transdermal delivery and release system also eliminates any possibility of dosage dumping.

A considerable number of transdermal drug delivery devices, e.g. transdermal patches, are known in the art. These devices generally provide for a drug or other active ingredients to be released by diffusion from the surface of the device and into the skin of the user. Current transdermal systems include reservoir systems and matrix-type systems. The reservoir systems generally comprise an enclosure of some kind filled with a fluid preparation of the active ingredient. In these systems, one side of the enclosure consists of a membrane which is permeable at least with respect to the active ingredient, and which is normally provided with a suitable adhesive. In the latter, matrix-type systems, the active ingredient is generally incorporated into a gel-type formulation or adhesive matrix, which is preferably also self-adhesive.

The present invention may be used in conjunction with any of the various suitable embodiments of transdermal patch delivery systems such, but not limited by, the systems described above.

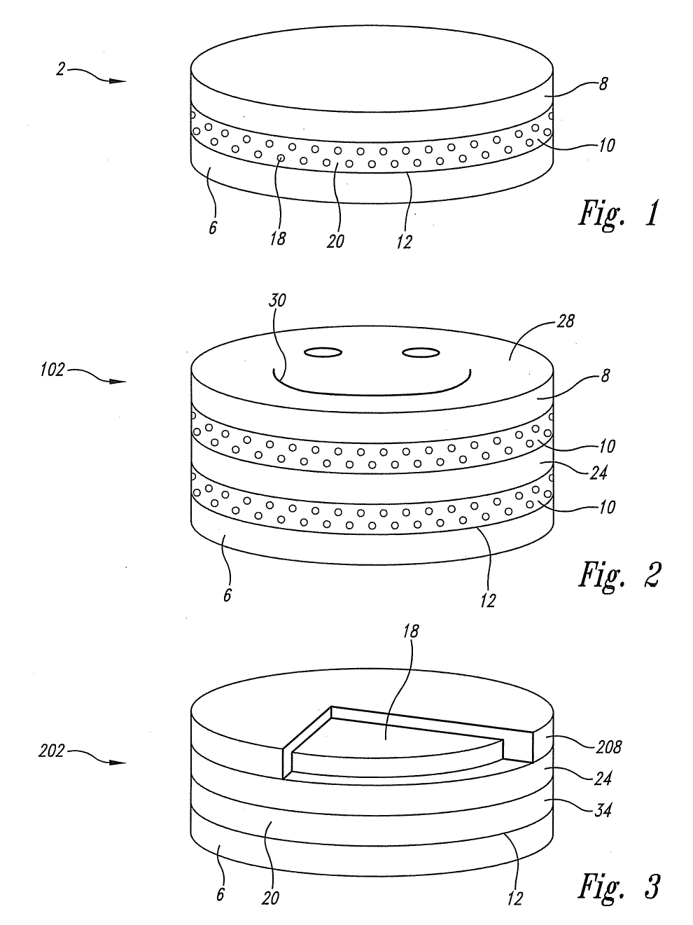

FIGS. 1-6 illustrate five exemplary patch types but it should be understood that they are intended to be exemplary only and various other types of transdermal drug delivery patches may be used in other exemplary embodiments. In each of the exemplary transdermal patches, the drug formulation and adhesive are each interposed between a backing layer and a removable liner layer that is removed when worn. As will be seen in the following figures, the drug formulation and adhesive may be intermixed or they may be provided in separate layers or within the same layer but in discrete separate portions such as in a matrix. Various suitable adhesives may be used and are available in the art.

Preferred therapeutic adhesives are available and advantageously allow for the patch to adhere firmly to the skin of the wearer, without being so adhesive so as to injure the wearer as the patch is removed, i.e. easily released from the skin. The adhesive preferably remains adhered to the transdermal patch, not the wearer's skin. The adhesive is selected for compatibility with the other components, i.e., the liner layer, backing layer and nature and form (gel, liquid, solid) of the drug formulation. The adhesive is preferably selected to be non-reactive with the ingredients. Adhesives used in transdermal patch systems are well known in the art and may include silicones and polyisobutylenes. In one advantageous embodiment, acrylic adhesives may be used. Pressure sensitive adhesives, such as acrylates, polyisobutylene/light mineral oil blends, polystryene-polybutadiene block copolymer/mineral oil blends, may be used in accordance with the present invention. The adhesive may advantageously be permeable to the ingredients so that the ingredients can pass through the adhesive layer and into the skin.

Now turning to the figures, each of FIGS. 1-4 illustrates an exemplary transdermal patch. While each of the transdermal patches illustrated in FIGS. 1-4 are shown to be round in shape, it should be understood that according to other exemplary embodiments, the patches may be elliptical, square, trapezoidal, triangle-shaped, heart-shaped, diamond-shaped, hexagonal or they may have other suitable decorative or functional shapes. The patches may vary in size and may range from a square patch being ¼ inch by ¼ inch to a square patch having the dimensions of about 4″ by 4″ in various exemplary embodiments. The patch may include a surface area ranging from about 0.0625 in² to about 16 in² in various exemplary embodiments. The round-shaped patches such as illustrated in the figures, may have a diameter ranging from ½ inch to 5 inches, but other dimensions and shapes may be used in other exemplary embodiments. The patches may advantageously be sized according to dosage, with larger patches appropriate for larger wearers, according to one exemplary embodiment.

FIG. 1 shows transdermal patch 2 having liner layer 6, backing layer 8 and drug-in-adhesive layer 10. Inner surface 12 will become an exposed surface that will contact the wearer's skin when liner layer 6 is removed and transdermal patch 2 is applied to a wearer. Drug-in-adhesive layer 10 includes drug formulation 18 which includes aloe vera and Vitamin B1 as described previously, intermixed with adhesive 20, also described previously. In the embodiment illustrated in FIG. 1, inner surface 12 is a surface of drug-in-adhesive layer 10. Drug formulation 18 may be a fluid such as a liquid or gel, or a solid.

Backing layer 8 may advantageously be a urethane material such as polyurethane. A urethane film is a very skin like material, is heat sealable and printable, with high MVTR, Moisture Vapor Transmission Rate, which is the measure of the ability of film to transmit moisture vapor or water and O2 transmission. Urethanes provide good resistance to oils and grease. Urethane is unaffected by acids, alkalis, solvents, ketones and alcohols. Urethane is a very breathable film which greatly reduces the chances of skin irritations. The urethane material may be either clear or colored. In other exemplary embodiments, other breathable materials may be used and will be chosen in conjunction with the adhesive used to affix the transdermal patch to the wearer's skin. Backing layer 8 is also chosen to be stretchable to allow transdermal patch 2 to move with and remain intact during, any body movement of the wearer.

Liner layer 6 is a releasable protective layer that is removed prior to transdermal patch 2 being worn by the wearer. After liner layer 6 is removed, inner surface 12 will contact the wearer's skin. The releasable liner layer 6 may be formed of various layers including paper or paper-containing layers or laminates, various thermoplastics such as extruded polyurethanes such as polyethylene, various polyester films, foil liners, or other suitable fabric layers coated or laminated to various polymers, as well as extruded polyethylene, Mylar, polyethylene terepathalate, various polyamides and the like. Each of the layers may include a surface area ranging from about 0.0625 in² to about 16 in² in various exemplary embodiments.

Now turning to FIG. 2, another exemplary transdermal patch 102 is shown. Transdermal patch 102 includes two drug-in-adhesive layers 10 separated by membrane layer 24. In other exemplary embodiments, more than the two drug-in-adhesive layers 10 may be provided with membrane 24 between adjacent drug-in-adhesive layers 10. Membrane 24 is chosen to be a suitably permeable material. Membrane 24 may be formed of various suitable and conventional materials available in the art, and advantageously allows for timed release of drug formulation 18 therethrough. Transdermal patch 102 of FIG. 2 also illustrates another aspect of the invention. Outer surface 28 of backing layer 8 includes decorative indicia 30 thereon. According to the embodiment in which backing layer 8 is formed of a colorless material, decorative indicia 30 may give the appearance of a tattoo. Various designs or logos may be used as decorative indicia 30 which may be variously or multiply colored. According to various exemplary embodiments, backing layer 8 may be multi-colored.

FIG. 3 shows exemplary transdermal patch 202 which includes liner layer 6, layer 34 of adhesive 20 and membrane 24. Drug formulation 18 is disposed within a recess of backing layer 208. Alternatively, backing layer 8 may be of even thickness and fastened peripherally to membrane 24 leaving room for drug formulation 18 to be centrally interposed between backing layer 6 and membrane 24. Although shaped differently, backing layer 208 is advantageously formed of the material described in conjunction with backing layer 8.

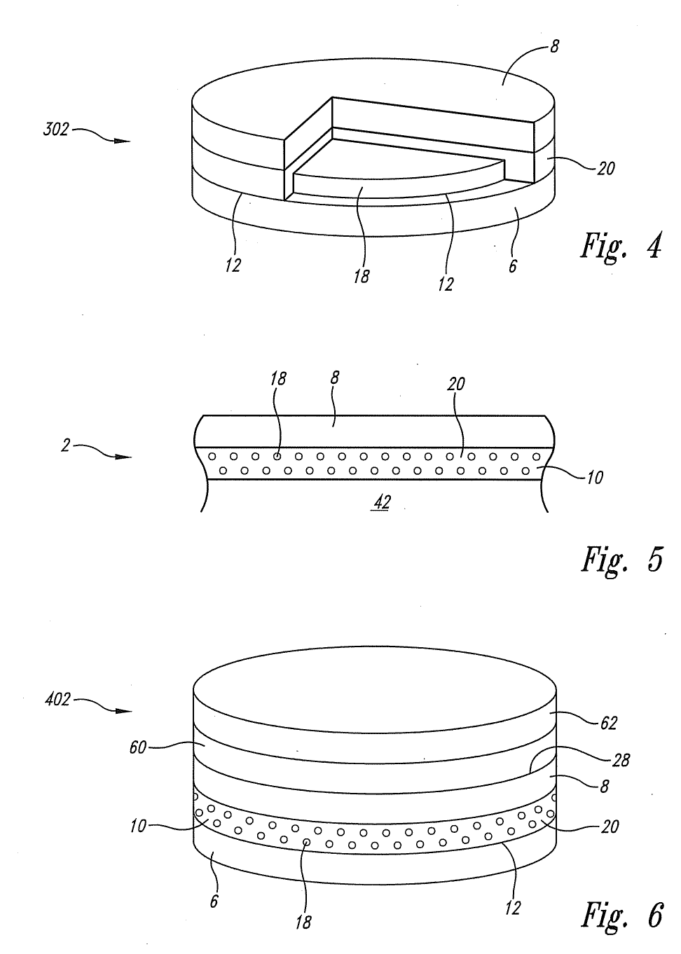

FIG. 4 illustrates transdermal patch 302 characterized by including a matrix in which drug formulation 18 will be in direct contact with the wearer's skin when liner layer 6 is removed. As can be seen in FIG. 4, inner surface 12 which is exposed when liner layer 6 is removed, includes at least one discrete portion of drug formulation 18 and at least one discrete separate section of adhesive 20, each of which will be directly in contact with the wearer's skin once liner layer 6 is removed. With respect to the wearer's skin, drug formulation 18 and adhesive 20 are arranged laterally next to one another, forming a matrix. In this embodiment, drug formulation 18 may advantageously be a gel.

FIG. 5 is a cross-sectional view showing the exemplary transdermal patch 2 previously shown in FIG. 2, after liner layer 6 has been removed and exposed surface 12 is affixed to wearer's skin 42.

FIG. 6 illustrates transdermal patch 402 having liner layer 6, backing layer 8 and drug-in-adhesive layer 10. Inner surface 12 will become an exposed surface that will contact the wearer's skin when liner layer 6 is removed and transdermal patch 402 is applied to a wearer. Drug-in-adhesive layer 10 includes drug formulation 18 intermixed with adhesive 20, each as described previously. Transdermal patch 402 also includes a layer of further insect repellant 60 disposed on outer surface 28 of backing layer 8, and outer liner 62 which may be similar to liner layer 6. The further insect repellant may be geraniol, oil of lemon eucalyptus, peppermint oil or other suitable insect repellants that provide immediate insect repelling qualities when outer liner 62 is removed and work in conjunction with drug formulation 18 to provide a longer period of insect repelling qualities.

In other exemplary embodiments, layer of further insect repellant 60 and outer liner 62 may be used in conjunction with the other transdermal patches described and/or illustrated herein.

Although the invention herein has been described with reference to particular embodiments, it is to be understood that these embodiments are merely illustrative of the principles and applications of the present invention. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is therefore to be understood that numerous modifications may be made to the illustrative embodiments and that other arrangements may be devised without departing from the spirit and scope of the present invention as defined by the appended claims. The appended claims should be construed broadly, to include other variants and embodiments of the invention, which may be made by those skilled in the art without departing from the scope and range of equivalents of the invention.

What is claimed is:

1. A device for transdermally administering a therapeutically useful dose of insect repellant, said device comprising:
a backing layer comprised of a breathable material; and
an adhesive and a drug formulation affixed to said backing layer, said drug formulation comprising a transdermally diffusible insect repellant and aloe vera, said transdermally diffusible insect repellant comprising at least Vitamin B1.

2. The device of claim 1, wherein said transdermally diffusible insect repellant comprises about 3 to 10 mg of said Vitamin B1 and said aloe vera is present in an amount ranging from about 0.1 to 1 mg.

3. The device as in claim 2, wherein said device includes an area within a range of about 0.0625 in² to about 16 in².

4. The device as in claim 1, wherein said drug formulation comprises about 5 mg of said Vitamin B1 and about 0.5 mg of said aloe vera.

5. The device of claim 1, wherein said adhesive and said drug formulation are intermixed and form a single layer.

6. The device of claim 1, wherein said adhesive forms a first layer and said drug formulation forms a second layer.

7. The device of claim 1, wherein an exposed surface of said device opposite said backing layer includes at least one discrete portion of said adhesive and at least one discrete separate portion of said drug formulation laterally adjacent said at least one portion of said adhesive such that when said device placed on a wearer's skin, said wearer's skin is in direct contact with said at least one portion of said drug formulation and with said at least one portion of said adhesive.

8. The device of claim 1, wherein at least said drug formulation comprises a gel and said adhesive comprises an acrylic adhesive.

9. The device of claim 1, wherein said breathable material comprises urethane.

10. The device of claim 1, wherein said backing layer includes decorative indicia on an outer surface thereof.

11. The device of claim 1, wherein said adhesive preferably adheres to said device and releasably joins said device to a wearer's skin.

12. The device as in claim 1, further comprising a releasable liner layer disposed opposite said backing layer, said drug formulation and said adhesive interposed between said releasable liner layer and said backing layer.

13. The device of claim 12, wherein said adhesive and said drug formulation are intermixed in a single intermediate layer.

14. The device of claim 12, wherein said adhesive forms a first intermediate layer, said drug formulation forms a second intermediate layer and further comprising a membrane layer disposed between said first intermediate layer and said second intermediate layer.

15. The device of claim 12, wherein said releasable liner layer is in direct confronting relationship with said at least one discrete portion of said drug formulation and with said at least one discrete portion of said adhesive.

16. The device of claim 12, wherein said releasable liner layer is a removable protective layer formed of paper or mylar.

17. The device of claim 1, wherein said adhesive and said drug formulation are affixed to an inner surface of said backing layer and further comprising a layer of further insect repellant disposed on an outer surface of said backing layer, and a removable outer liner disposed adjacent said layer of further insect repellant.

18. The device of claim 17, wherein said layer of further insect repellant includes at least one of geraniol, oil of lemon eucalyptus and peppermint oil.

19. A transdermally diffusible insect repellant formed on a transdermal patch and comprising a drug formulation including at least Vitamin B1 and aloe vera.

20. The transdermally diffusible insect repellent as in claim 19, wherein said transdermally diffusible insect repellent comprises about 5 mg of said Vitamin B1 and about 0.5 mg of said aloe vera.

21. The transdermally diffusible insect repellent as in claim 19, wherein said transdermally diffusible insect repellant comprises about 3 to 10 mg of said Vitamin B1 and said transdermal patch includes a surface area within a range of about 0.0625 in² to about 16 in².

22. The transdermally diffusible insect repellent as in claim 19, wherein said aloe vera is present in an amount ranging from about 0.1 to 1 mg.

23. The transdermally diffusible insect repellent as in claim 19, further comprising an adhesive, said adhesive and said drug formulation affixed to a first surface of a backing layer of said transdermal patch that is adapted to be releasably joined to a wearer's skin by means of said adhesive, and wherein said transdermally diffusible insect repellent is diffusible through a human's skin.

24. The transdermally diffusible insect repellent as in claim 23, further comprising a layer of further insect repellant disposed on an opposed second surface of said backing layer and a removable outer liner disposed adjacent said layer of further insect repellant, wherein said layer of further insect repellant includes at least one of geraniol, oil of lemon eucalyptus and peppermint oil.

25. A method for transdermally administering a therapeutically useful dose of insect repellant, said method comprising:
providing a patch comprising a backing layer formed of a breathable material and having an outer surface, and a drug formulation and an adhesive affixed to an opposed inner surface of said backing layer, said drug formulation comprising a transdermally diffusible insect repellant and aloe Vera, said transdermally diffusible insect repellant comprising at least Vitamin B1; and
removably affixing said patch to a wearer's skin by means of said adhesive thereby causing at least said transdermally diffusible insect repellant to diffuse through said wearer's skin.

26. The method of claim 25, wherein
said patch further comprises a removable liner layer, said drug formulation and said adhesive interposed between said removable liner layer and said backing layer, and
further comprising removing said removable liner layer prior to said removably affixing.

27. The method of claim 25, wherein said drug formulation and said adhesive form a single layer that is affixed to said wearer's skin by means of said removably affixing.

28. The method of claim 25, further comprising:
leaving said patch on said wearer's skin for a first interval of time, said first interval of time ranging from about 1 hour to about 36 hours; and
removing said patch from said wearer's skin after said first interval of time has lapsed.

29. The method of claim 28, wherein said leaving said patch on said wearer's skin for said first interval of time allows for diffusion of said transdermally diffusible insect repellant into said wearer's bloodstream in an amount sufficient to repel insects for about 36 hours.

30. The method of claim 29, wherein said drug formulation and said adhesive are in separate layers with a membrane therebetween, said outer surface has decorative indicia disposed thereon and said drug formulation includes about 3 to 10 mg of said Vitamin B1 and about 0.1 to 1.0 mg of said aloe vera.
